(19) United States
(12) Patent Application Publication
(10) Pub. No.: US 2007/0291856 A1
(43) Pub. Date: Dec. 20, 2007

(54) Clock regeneration system and method for wireless media content delivery systems

(75) Inventors: Steven S. Fastert, Chelmsford, MA (US); Jeff Winston, Subbury, MA (US); Mark Sankey, Acton, MA (US); Craig A. Thomas, Waltham, MA (US); John A. Flanders, Ashland, MA (US); Bhavin Patel, Jamaica Plan, MA (US); Samuel J. MacMullan, Carlisle, MA (US)

Correspondence Address: FIALA & WEAVER, P.L.L.C.;C/O INTELLEVATE, P.O. BOX 52050, MINNEAPOLIS, MN, 55402, US

(73) Assignee: Radiospire Networks, Inc., Concord, MA (US)

(21) Appl. No.: 11/580,135

(22) Filed: Oct. 13, 2006

Related U.S. Application Data
(60) Provisional application No. 60/814,874, filed on Jun. 20, 2006.

(51) Int. Cl. H04B 1/66

(52) U.S. Cl. 375/240.28

(57) ABSTRACT

A improved method and system for regenerating a video pixel and/or audio sampling clock in a system that wirelessly transfers video and audio content from a content source to a content sink.

### CROSS-REFERENCE TO RELATED APPLICATIONS

This application claims priority to U.S. Provisional Patent Application No. 60/814,874 entitled “Clock Regeneration Method for Wireless Media Content Delivery Systems,” filed Jun. 20, 2006, the contents of which are incorporated by reference herein in their entirety.

### BACKGROUND OF THE INVENTION

1. Field of the Invention

The invention is generally related to wireless communication systems. In particular, the present invention is related to a system and method for clock regeneration in a wireless communication system that delivers media content from a content source to a content sink.

2. Background

In a system that wirelessly transfers media content between a content source and a content sink, some level of synchronization must typically be maintained between certain clocks on the transmit and receive sides of the wireless link. For example, when wirelessly transferring video content, it may be necessary to maintain synchronization between a pixel clock (typically provided by the content source) on the transmit side and an independent or regenerated pixel clock on the receive side of the wireless link in order to ensure acceptable performance when displaying the video content at the content sink. Similarly, when wirelessly transferring audio content, it may be necessary to maintain synchronization between audio sampling clocks on the transmit and receive sides of the wireless link in order to ensure acceptable performance when playing back the audio content at the content sink. Maintaining clock synchronization is particularly important when one is wirelessly transferring digital media content at extremely high data rates, such as the data rates associated with digital media content normally transmitted across wired HDMI or DVI interfaces.

U.S. patent application Ser. No. 11/117,467, filed Apr. 29, 2005, which is incorporated by reference herein in its entirety, describes a clock regeneration method for use in the wireless delivery of video content, such as digital video content, from a content source to a content sink. In accordance with this method, a transmit (TX) wireless media adapter periodically samples a clock signal provided by a content source and the frequency of the clock is thereby determined. The TX wireless media adapter then periodically sends control data indicating the clock frequency over a wireless link to a receive (RX) wireless media adapter. The RX wireless media adapter receives the control data and extracts the clock information. The RX wireless media adapter then uses the clock frequency as specified by the control data to recreate the clock and provide it to a content sink.

The details of the particular approach will now be described with respect to FIGS. 1A and 1B of the present application. As shown in FIG. 1A, a TX wireless media adapter 102 includes a first cycle time counter 104 and a second cycle time counter 106. First cycle time counter 104 receives as input an input pixel clock and a time reference period. The input pixel clock is provided from a content source or is otherwise derived from information provided from the content source, and the time reference period is chosen to be an integer number of pixel clocks. For example, the time reference period may be equal to a Horizontal Blanking Interval (HBI), a horizontal line period, or the like. Based on the input pixel clock and the time reference period, cycle time counter 104 derives and outputs a value N which is defined as the number of pixel clocks per time reference period. Using a time reference period that is an integer number of pixel clocks ensures that N is a constant integer for any video format.

Second cycle time counter 106 receives as input the time reference period discussed above and a transmitter (TX) reference clock for TX wireless media adapter 102. Based on the time reference period and the TX reference clock, second cycle time counter 106 derives and outputs a cycle time stamp (CTS) which is defined as the number of TX reference clocks per time reference period. The values of N and CTS are updated at the end of every time reference period and transmitted by TX wireless media adapter 102 over the air to an RX wireless media adapter in the form of video clock regeneration packets. The transmitted N and CTS values essentially represents a ratio between the TX reference clock and the input pixel clock.

FIG. 1B illustrates an RX wireless media adapter 152 in further accordance with this approach. As shown in FIG. 1B, RX wireless media adapter 152 includes “divide by CTS” logic 154 and “multiply by N” logic 156. RX wireless media adapter 152 wirelessly receives video clock regeneration packets from TX wireless media adapter 102 and recovers the N and CTS values therefrom. “Divide by CTS” logic 154 receives as input a receiver (RX) reference clock for RX wireless media adapter 152 and the CTS value. The frequency of the RX reference clock is ideally the same as that of the TX reference clock for TX wireless media adapter 102, although in practice it may vary from the RX reference clock by a few parts per million (ppm).

Based on the RX reference clock and the CTS value, “divide by CTS” logic 154 outputs a value which is determined by dividing the RX reference clock by CTS. This output is then multiplied by N in logic 156 to provide a regenerated pixel clock which is provided to a content sink. In accordance with this approach, the shorter the time reference period, the better the tracking between actual pixel clock frequency and the regenerated pixel clock frequency.

The foregoing method provides several distinct benefits. For example, the method permits the same logic to be used to support a variety of video formats having different pixel clocks. The method also permits the high-frequency TX and RX reference clocks to be used for both wireless transfer operations and clock regeneration. Furthermore, by providing periodic transfer of updated N and CTS values, the method compensates for imprecision that results when CTS is rounded to an integer number, for any variability in the time reference period, and for frequency offset drift between the input pixel clock and the TX reference clock.

However, it has been observed that, depending upon the internal circuit implementation of a display (e.g., a monitor, flat panel display, etc.), the clock regeneration method described above may yield unwanted image display artifacts. These artifacts may include an invalid first active video line (i.e., first visible video line) or image jitter with respect to either a portion of a video image or the entire video image. This appears to be due to the amount and/or rate of change of the regenerated pixel clock as provided by the foregoing method.

Another problem that occurs in a system implementing the foregoing clock regeneration method is that due to the independent nature of the sources (e.g., crystal oscillator, clock oscillator, etc.) for the TX reference and RX reference clocks, there will be a persistent, potentially drifting, frequency offset between TX wireless media adapter 102 and RX wireless media adapter 152. This offset will adversely affect the accuracy of any recovered clock generated from the RX reference clock.

What is needed, then, is an improved clock regeneration method for the wireless delivery of video content that avoids the shortcomings of the foregoing method. In particular, the improved clock regeneration method should produce both a smaller amount of change and rate of change in a regenerated pixel clock as compared to the foregoing method. Furthermore, the improved clock regeneration method should also be applicable to the regeneration of an audio sampling clock, thereby also facilitating the wireless delivery of audio content from a content source to a content sink.

What is also needed is an additional method that can be used in either a standalone manner, in conjunction with the N and CTS clock regeneration method described above, or with other clock regeneration methods, that compensates for frequency offset between reference clock sources on the transmit and receive sides of a wireless link.

### BRIEF SUMMARY OF THE INVENTION

The present invention provides an improved clock regeneration method for the wireless delivery of video content that avoids the shortcomings of the N and CTS method described in the Background Section above. In particular, a clock regeneration method in accordance with the present invention produces both a smaller amount of change and rate of change in a regenerated pixel clock as compared to the N and CTS method and can accommodate any frequency offset between the TX and RX reference clocks. A clock regeneration method in accordance with the present invention is also applicable to the regeneration of an audio sampling clock, thereby also facilitating the wireless delivery of audio content from a content source to a content sink.

In particular, a method for regenerating a pixel clock in accordance with the present invention includes several steps. First, an integer value is received, the integer value representing a number of remote (e.g., transmit) reference clock cycles generated during a time reference period associated with one or more video frames integer divided by a number of horizontal video lines associated with the video frame(s). Second, an input reference signal is generated that has a period equal to the period of a local (e.g., receive) reference clock signal multiplied by the integer value described above. Third, using a phase lock loop, the input reference signal frequency is multiplied by a number of pixels associated with the horizontal video line to provide a regenerated pixel clock. The time reference period associated with the video frame may be one of a video frame period, a video horizontal line period or a period associated with multiple frames of video. The method may further include applying an adjustment to the input reference signal, wherein the adjustment is applied by extending the period of the input reference signal by no more than one clock cycle of the local reference clock per period of the input reference signal.

A system for regenerating a pixel clock in accordance with an embodiment of the present invention includes a reference signal generator and a phase lock loop. The reference signal generator is configured to generate an input reference signal having a period equal to a period of a local reference clock signal multiplied by an integer value, wherein the integer value represents a number of remote reference clock cycles generated during a time reference period associated with one or more video frames integer divided by a number of horizontal video lines associated with the video frame(s). The phase lock loop is configured to multiply the input reference signal by a number of pixels associated with a horizontal video line to provide a regenerated pixel clock. The time reference period associated with the video frame may be one of a video frame period, a video horizontal line period, or a period associated with multiple frames of video. The reference signal generator may be further configured to apply an adjustment to the input reference signal, wherein the adjustment is applied by extending the period of the input reference signal by no more than one clock cycle of the local reference clock per period of the input reference signal.

A method for regenerating an audio sampling clock in accordance with the present invention includes several steps. First, an integer value is received, the integer value representing a number of remote (e.g., transmit) reference clock cycles generated during a time reference period associated with one or more audio packets integer divided by M, wherein M is a positive integer. Second, an input reference signal is generated having a period equal to the period of a local (e.g., receive) reference clock signal multiplied by the integer value described above. Third, using a phase lock loop, the input reference signal frequency is multiplied by a number of bits associated with each audio packet to provide a regenerated audio sampling clock. The time reference period associated with one or more audio packets may be a period of M audio packets. The method may further include applying an adjustment to the input reference signal, wherein the adjustment is applied by extending the period of the input reference signal by no more than one clock cycle of the local reference clock per period of the input reference signal.

A system for regenerating an audio sampling clock in accordance with an embodiment of the present invention includes a reference signal generator and a phase lock loop. The reference signal generator is configured to generate an input reference signal having a period equal to a period of a local reference clock signal multiplied by an integer value, wherein the integer value represents a number of remote reference clock cycles generated during a time reference period associated with one or more audio packets integer divided by M, wherein M is a positive integer. The phase lock loop is configured to multiply the input reference signal frequency by a number of bits associated with each audio packet to provide a regenerated audio sampling clock. The time reference period associated with one or more audio packets may be a period of M audio packets. The reference signal generator may be further configured to apply an adjustment to the input reference signal, wherein the adjustment is applied by extending the period of the input reference signal by no more than one clock cycle of the local reference clock per period of the input reference signal.

The present invention also provide a method that can be used in either a standalone manner, in conjunction with the N and CTS clock regeneration method described in the Background Section above, or with an improved clock regeneration method described herein, that compensates for frequency offset between reference clock sources on the transmit and receive sides of a wireless link.

In particular, a method for controlling a regenerated clock in accordance with the present invention includes several steps. First, wirelessly received media content, such as video or audio content, is stored in a storage element. Second, the storage element is monitored to determine if the amount of stored media content has reached a programmed threshold. Third, responsive to a determination that the amount of stored media content has reached the programmed threshold, the rate of a regenerated clock associated with the media content, such as a regenerated pixel or audio sampling clock, is changed. For example, in one implementation, the storage element is monitored to determine if the amount of stored media content has reached a high threshold and responsive to a determination that the amount of stored media content has reached the high threshold, the rate of the regenerated clock is increased. Additionally or alternatively, the storage element is monitored to determine if the amount of stored media content has reached a low threshold and responsive to a determination that the amount of stored media content has reached the low threshold, the rate of the regenerated pixel clock is decreased.

A system for controlling a regenerated clock in accordance with an embodiment of the present invention includes a storage element and a recovered clock generator. The storage element is configured to store wirelessly-received media content, such as video or audio content. The recovered clock generator is configured to monitor the storage element to determine if the amount of stored media content has reached a programmed threshold and to change the rate of a regenerated clock associated with the media content, such as a regenerated pixel or audio clock, responsive to a determination that the amount of stored media content has reached the programmed threshold. The recovered clock generator may be configured to monitor the storage element to determine if the amount of stored media content has reached a high threshold and to increase the rate of the regenerated clock responsive to a determination that the amount of stored media content has reached the high threshold. Additionally or alternatively, the recovered clock generator may be configured to monitor the storage element to determine if the amount of stored media content has dropped to a low threshold and to decrease the rate of the regenerated pixel clock responsive to a determination that the amount of stored media content has dropped to the low threshold.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1A is a block diagram of a transmit (TX) media adapter that generates and wirelessly transmits control data used for the regeneration of a pixel clock associated with wirelessly transmitted video content.

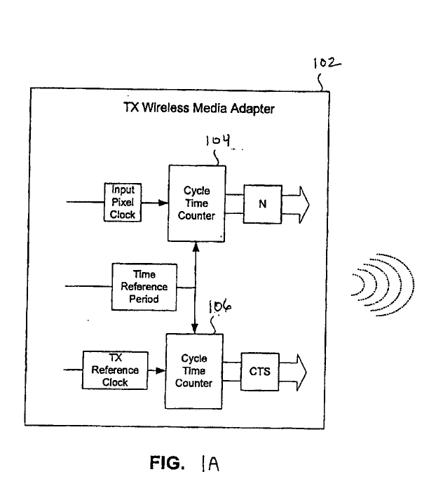

FIG. 1B is a block diagram of a receive (RX) media adapter that regenerates a pixel clock associated with wirelessly transmitted video content.

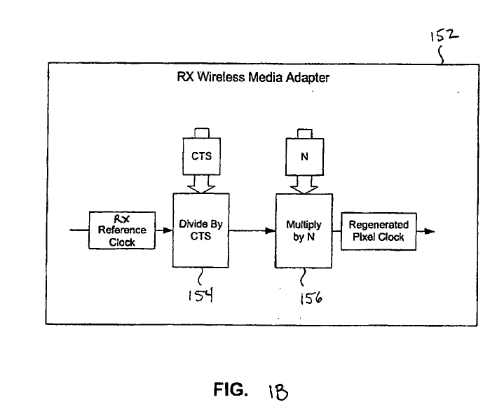

FIG. 2 is a block diagram of a TX wireless media adapter that generates and wirelessly transmits control data used for the regeneration of a pixel clock associated with wirelessly transmitted video content in accordance with an embodiment of the present invention.

FIG. 3 is a block diagram of a TX wireless media adapter that generates and wirelessly transmits control data used for the regeneration of an audio sampling clock associated with wirelessly transmitted audio content in accordance with an embodiment of the present invention.

FIG. 4 is a block diagram of an RX wireless media adapter that regenerates a pixel clock associated with wirelessly transmitted video content in accordance with an embodiment of the present invention.

FIG. 5 illustrates the structure of an analog phase lock loop (PLL) that may be used to implement the RX wireless media adapter of FIG. 4.

FIG. 6 is a block diagram of an RX wireless media adapter that regenerates an audio sampling clock associated with wirelessly transmitted audio content in accordance with an embodiment of the present invention.

FIG. 7 illustrates the structure of an analog phase lock loop (PLL) that may be used to implement the RX wireless media adapter of FIG. 6.

FIG. 8 is a block diagram of an RX wireless media adapter that compensates for frequency offset drift between a remote (e.g., transmit) reference clock and a local (e.g., receive) reference clock in regenerating a clock signal in accordance with an embodiment of the present invention.

FIG. 9 depicts a storage element used to implement the RX wireless media adapter of FIG. 8.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### A. Pixel Clock Regeneration Method in Accordance with an Embodiment of the Present Invention

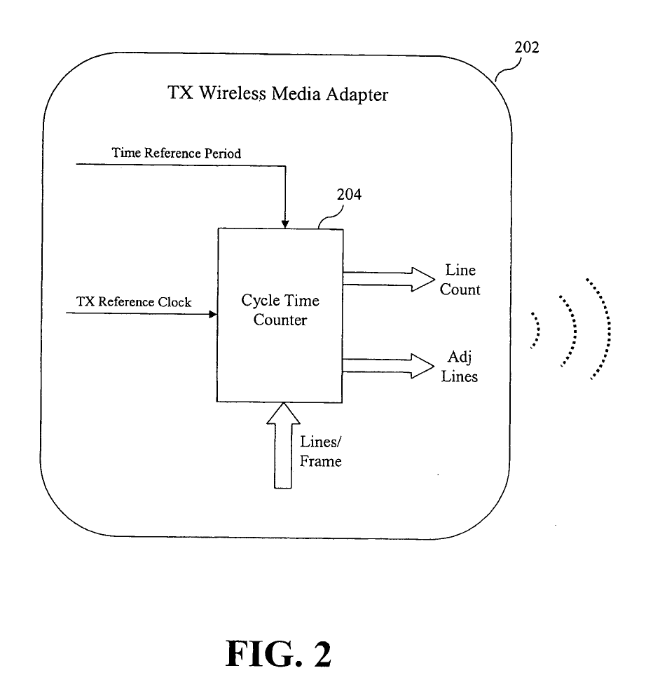

FIG. 2 is a block diagram of a transmit (TX) wireless media adapter 202 in accordance with an embodiment of the present invention. TX wireless media adapter 202 operates to receive video content from a content source (not shown in FIG. 2) and to convert the video content into wireless signals for transmission over the air. In addition, TX wireless media adapter 202 includes components for generating and wirelessly transmitting control data used to regenerate a pixel clock associated with the wirelessly transmitted video content. In an embodiment, the components of TX wireless media adapter 202 are implemented as digital logic in an application specific integrated circuit (ASIC), although the invention is not so limited.

As shown in FIG. 2, TX wireless media adapter 202 includes a cycle time counter 204 that receives as input a TX reference clock, a time reference period, and an integer value specifying a number of lines per video frame.

The TX reference clock is a clock signal that is generated from a clock source physically located within TX wireless media adapter 202 and is preferably used both for the wireless transmission of video content from TX wireless media adapter 202 and for generating control data used for pixel clock regeneration in accordance with the method described herein. By using the TX reference clock to perform both these functions, an embodiment of the present invention avoids the cost and complexity associated with having to use two separate clock sources. In order to facilitate high data transfer rates, the TX reference clock preferably has a much higher frequency than the pixel clock associated with the video content. In particular, the frequency of the TX reference clock is preferably such that the period of the TX reference clock is much less than the period of a horizontal video line.

The time reference period received by cycle time counter 204 is based on some aspect of the video content being received from the content source.

In a preferred embodiment, the time reference period is preferably the video frame (or field) period, which is equal to the number of pixel clock cycles in a video frame. However, it should be apparent to persons skilled in the art that other time reference periods could be used, including but not limited to a video horizontal line period or a period associated with multiple frames of video.

Like the time reference period, the number of lines per video frame is essentially a predefined value that depends on the format of the video data being received from the video content source. When the format of the video content received by TX wireless media adapter 202 changes, it is to be expected that both the time reference period and the number of lines per video frame will change as well.

Given the time reference period and the TX reference clock, cycle time counter 204 measures an integer quantity referred to herein as “Frame Count”, wherein:

Frame Count=Number of TX reference clocks/video frame period.

From Frame Count and the number of lines per video frame, an integer quantity referred to herein as “Line Count” is derived using:

$$⌊ \frac{Frame Count}{lines per video frame} ⌋ = Line Count .$$

Note that the operation └x┘ above provides the greatest integer that is less than x, so Line Count is an integer quantity. In addition, the operation

$$⌊ \frac{x}{y} ⌋$$

represents integer dividing x by y.

Because the └x┘ operation is essentially a rounding down operation, the calculation of Line Count in this manner results in an overall loss of a number of TX reference clocks per video frame period. An embodiment of the present invention compensates for this loss by identifying the number of lost clocks and transmitting the number to a receive (RX) wireless media adapter, which then alters the rate of a regenerated pixel clock to compensate for the lost clocks. In order to limit the rate at which the regenerated pixel clock period can change, an embodiment of the present invention only allows the period of an RX phase lock loop (PLL) reference generator (located within the RX wireless media adapter) to increase by one RX reference clock per horizontal video line.

The number of lost TX reference clocks is captured using the variable “Adjustment Lines”, which is calculated by cycle time counter 204 within TX wireless media adapter 202 using:

Adjustment Lines=Frame Count−(Line Count*lines per video frame).

The derivation of this quantity ensures that Adjustment Lines is always less than the number of lines per video frame. Adjustment Lines is then an integer quantity that in one embodiment represents the number of lines per frame in which the RX PLL reference generator output period is increased by one RX reference clock. In an alternative embodiment, Adjustment Lines is used to derive a fractional quantity that represents the fraction of video frames in which the RX PLL reference generator output period is increased by one RX reference clock for all of the lines in the video frame. The RX wireless media adapter calculates this fraction by dividing Adjustment Lines by lines per video frame.

After deriving Line Count and Adjustment Lines, TX wireless media adapter 202 wirelessly transmits a video format indicator, Line Count and Adjustment Lines to an RX wireless media adapter. These values need only be sent once each time a new video format is selected. This is in contrast to the method described in the Background section above, which sends updated CTS and N values every time reference period (e.g., every horizontal line period). Since the video format, Line Count and Adjustment Lines are sent only once per video format, these values can be transmitted using a method that guarantees a high probability of successful (i.e., non-errored) delivery, without consuming a substantial amount of bandwidth on the wireless link.

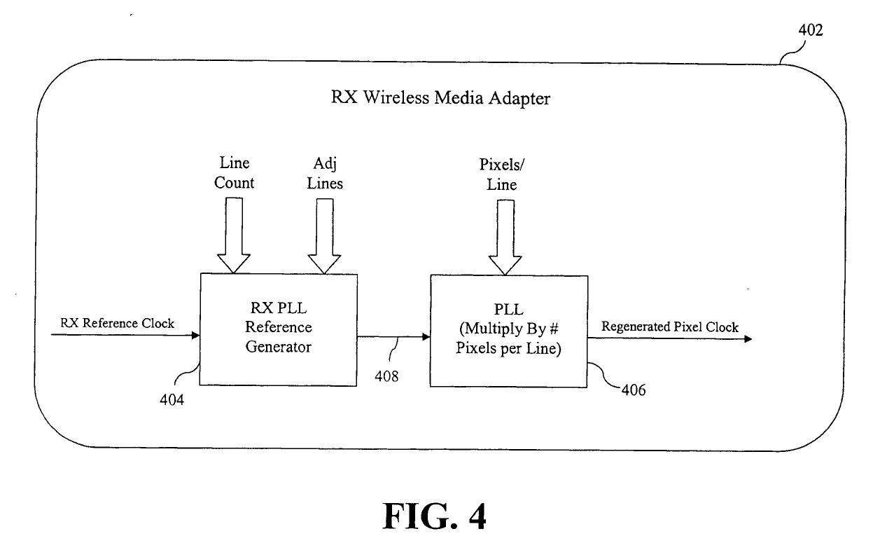

FIG. 4 is a block diagram of an RX wireless media adapter 402 in accordance with an embodiment of the present invention. RX wireless media adapter 402 operates to receive wireless signals from TX wireless media adapter 202 and to convert the wireless signals into video content for display by a content sink (not shown). In addition, RX wireless media adapter 402 includes components for regenerating a pixel clock associated with the wirelessly transmitted video content. In an embodiment, the components of RX wireless media adapter 402 are implemented as digital logic in an application specific integrated circuit (ASIC), although the invention is not so limited.

As shown in FIG. 4, RX wireless media adapter 402 includes an RX phase lock loop (PLL) reference generator 404 and an adjustable PLL 406. RX PLL reference generator 404 receives as input a RX reference clock, a number of lines per video frame (not shown), Line Count and Adjustment Lines. The RX reference clock is a clock signal that is generated from a clock source physically located within RX wireless media adapter 402 and is preferably used both for the wireless reception of video content from TX wireless media adapter 202 and for pixel clock regeneration in accordance with the method described herein. By using the RX reference clock to perform both these functions, an embodiment of the present invention avoids the cost and complexity associated with having to use two separate clock sources. The RX reference clock is selected to have an identical frequency (or as close as possible) to the TX reference clock of TX wireless media adapter 202, although in practice the TX and RX reference clocks may vary by a few parts per million (ppm).

The number of lines per video frame received as input by RX PLL reference generator 404 is a predefined value that is selected based on a video format indicator which is wirelessly communicated from TX wireless media adapter 202 in a manner previously described. The integer values Line Count and Adjustment Lines are also wirelessly communicated from TX wireless media adapter 202 and the generation and transmission of these values has already been described.

RX PLL reference generator 404 derives a BASE, 50% duty cycle input reference signal 408 to PLL 406 with a BASE input reference period equal to the RX reference clock times Line Count. This BASE input reference period is always slightly less than the horizontal line period, due to the inherent rounding down operation of the generation method.

PLL 406 receives as input the number of pixels per horizontal video line and the input reference signal 408 from the RX PLL reference generator.

The number of pixels per horizontal video line is a predefined value that is selected based on a video format indicator which is wirelessly communicated to RX wireless media adapter 402 by TX wireless media adapter 202 in a manner previously described.

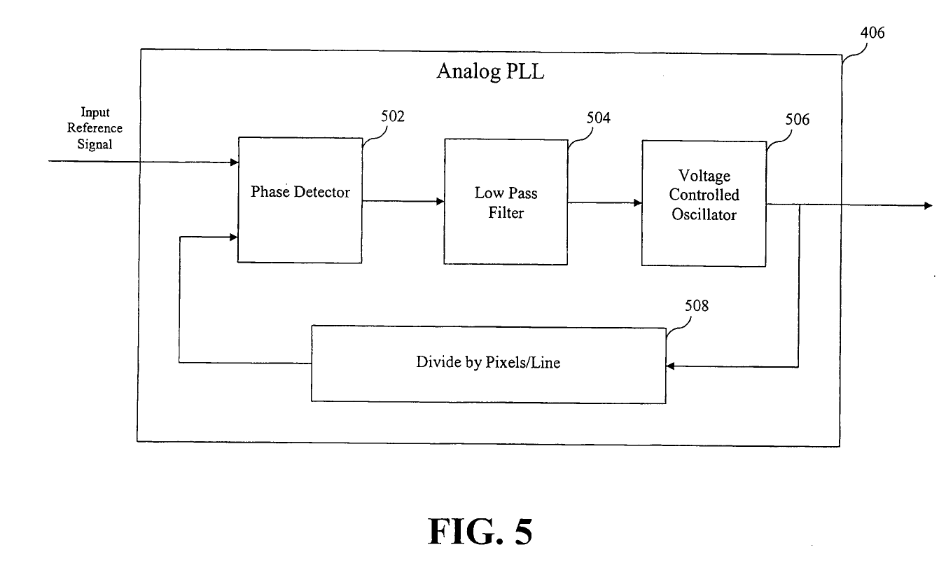

As will be appreciated by persons skilled in the art, the basic operation of a PLL is to produce an output signal which is both phase aligned and rate locked to an input reference signal, where the rate of the output signal is equal to A/B times the rate of the input signal. Additionally, due to the basic implementation of a PLL (e.g., a closed loop feedback system), the response time (e.g., the control loop bandwidth) of the PLL is typically much slower than the period of the input reference signal. The effect of this is that the output signal will not respond very rapidly to a rapid change in either the phase or rate of the input reference signal. In other words, the PLL tends to smooth out rapid changes in the input signal. The PLL control loop bandwidth and parameters A/B can be set based on the requirements of a particular application. FIG. 5 depicts an example analog implementation of PLL 406 that includes a phase detector 502, a low pass filter 504, a voltage controlled oscillator 506 and a feedback module 508.

The A/B parameters for PLL 406 are programmed to equal the number of pixels per horizontal video line. The effect of setting the A/B parameters in this manner is to generate an output signal that is A/B times the input signal.

Thus, in this case, the input reference signal 408 from RX PLL reference generator (representative of the horizontal line rate) is multiplied by the number of pixels per horizontal line to generate a pixel clock rate, or regenerated pixel clock.

Furthermore, in one embodiment of the present invention, RX PLL reference generator 404 increases the period of the input reference signal 408 (representative of the horizontal line period) by one RX reference clock for the first Adjustment Lines of the total number of lines in each video frame. RX PLL reference generator 404 then reduces the period of the input reference signal 408 back to the BASE input reference period for the remaining number of lines in the video frame. The remaining number of lines in the video frame will equal the total number of lines per video frame less Adjustment Lines.

Furthermore, in another embodiment, RX PLL reference generator 404 increases the period of the input reference signal 408 (representative of the horizontal line period) by one RX reference clock for all of the lines in a number of video frames E. Then RX PLL reference generator 404 reduces the period of the input reference signal 408 back to the BASE input reference period for all of the lines in a number of video frames F, such that the total number of video frames D over which the adjustment occurs is:

D=(Adjustment Lines/lines per video frame*E)+((1−Adjustment Lines)/lines per video frame*F).

The effects of the operation of RX PLL reference generator 404 and PLL 406 as previously described are as follows:

(1) The rate of change in input reference signal 408 is constrained to one RX reference clock period per horizontal video line, versus the N and CTS method described in the Background Section, in which the rate of change in the regenerated clock is not constrained (e.g., the output rate changes instantaneously whenever N and CTS are updated);

(2) The rate of change of the regenerated pixel clock (i.e., the output of PLL 406) is further reduced or smoothed due to the control loop bandwidth implementation of PLL 406; and

(3) The total amount of change in the period of input reference signal 408 in any video frame is always constrained to be a number of clocks that is less than the number of lines per video frame, versus the N and CTS method described in the Background Section, in which the amount of change per any N/CTS update period was only constrained by the maximum period difference between the TX reference clock and the RX reference clock.

The overall effect of the foregoing pixel clock regeneration method is to generate a regenerated pixel clock that does not cause any of the display artifacts caused by the N and CTS method described in the Background Section.

### B. Audio Sampling Clock Regeneration Method in Accordance with an Embodiment of the Present Invention

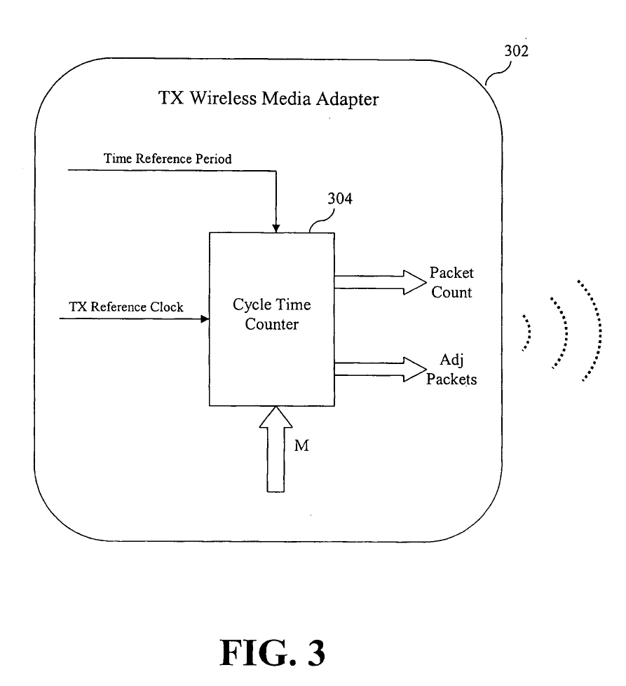

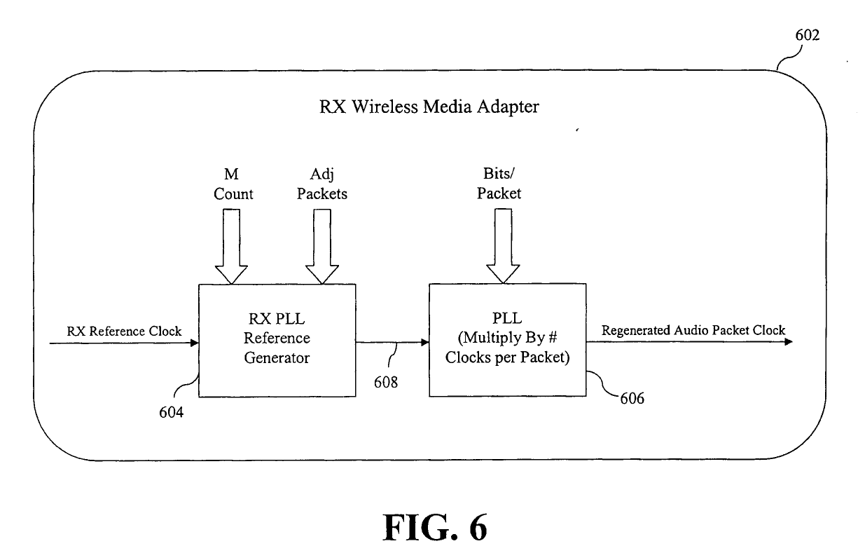

The foregoing approach to pixel clock regeneration can also be used to regenerate an audio sampling clock in a system that wirelessly transmits audio content from a content source to content sink. FIGS. 3 and 6 provide block diagrams of a TX wireless media adapter 302 and an RX wireless media adapter 602 that may be used to implement such a system.

As shown in FIG. 3, TX wireless media adapter 302 includes a cycle time counter 304 that receives as input a TX reference clock, a time reference period, and an integer value specifying a number of audio packets (M). The TX reference clock is a clock signal that is generated from a clock source physically located within TX wireless media adapter 302 and is preferably used both for the wireless transmission of audio content from TX wireless media adapter 302 and for generating control data used for audio sampling clock regeneration in accordance with the method described herein. In order to facilitate high data transfer rates, the TX reference clock preferably has a much higher frequency than the audio sampling clock associated with the video content. In particular, the frequency of the TX reference clock is preferably such that the period of the TX reference clock is much less than the period of an audio packet.

The time reference period received by cycle time counter 304 is based on some aspect of the audio content being received from the content source. In a preferred embodiment, the time reference period is equal to the number of audio sampling clock cycles in a single audio packet (or “packet period”) multiplied by M, wherein M is a positive integer. However, it should be apparent to persons skilled in the art that other time reference periods could be used.

Like the time reference period, the value M is essentially a predefined value that depends on the format of the audio data being received from the audio content source. When the format of the audio content received by TX wireless media adapter 302 changes, it is to be expected that both the time reference period and M will change as well.

Given the time reference period and the TX reference clock, cycle time counter 304 measures an integer quantity referred to herein as “M Count”, wherein:

M Count=Number of TX reference clocks/M audio packets.

From M Count and the number of bits per audio packet, an integer quantity referred to herein as “Packet Count” is derived using:

$$⌊ \frac{M Count}{bits per audio packet} ⌋ = Packet Count .$$

Note that the operation └x┘ above provides the greatest integer that is less than x, so Packet Count is an integer quantity. In addition, the operation

$$⌊ \frac{x}{y} ⌋$$

represents integer dividing x by y.

Because the └x┘ operation is essentially a rounding down operation, the calculation of Packet Count in this manner results in an overall loss of a number of TX reference clocks per each period of M audio packets. An embodiment of the present invention compensates for this loss by identifying the number of lost clocks and transmitting the number to a receive (RX) wireless media adapter, which then alters the rate of a regenerated audio sampling clock to compensate for the lost clocks. In order to limit the rate at which the regenerated audio sampling clock period can change, an embodiment of the present invention only allows the period of an RX phase lock loop (PLL) reference generator (located within the RX wireless media adapter) to increase by one RX reference clock per audio packet.

The number of lost TX reference clocks is captured using the variable “Adjustment Packets”, which is calculated by cycle time counter 304 within TX wireless media adapter 302 using:

Adjustment Packets=M Count−(Packet Count*M).

The derivation of this quantity ensures that Adjustment Packets is always less than M. Adjustment Packets is then an integer quantity in one embodiment that represents the number of audio packets per M audio packets in which the RX PLL reference generator output period is increased by one RX reference clock. In an alternative embodiment, Adjustment Packets is used to derive a fractional quantity that represents the fraction of blocks of M audio packets in which the RX PLL reference generator output period is increased by one RX reference clock. The RX wireless media adapter calculates this fraction by dividing Adjustment Packets by M.

After deriving M Count and Adjustment Packets, TX wireless media adapter 302 wirelessly transmits an audio format indicator, Packet Count and Adjustment Packets to an RX wireless media adapter. These values need only be sent once each time a new audio format is selected. Since the audio format, Packet Count and Adjustment Packets are sent only once per audio format, these values can be transmitted using a method that guarantees a high probability of successful (i.e., non-errored) delivery, without consuming a substantial amount of bandwidth on the wireless link.

As shown in FIG. 6, RX wireless media adapter 602 includes an RX phase lock loop (PLL) reference generator 604 and an adjustable PLL 606.

RX PLL reference generator 604 receives as input an RX reference clock, M, M Count and Adjustment Packets. The RX reference clock is a clock signal that is generated from a clock source physically located within RX wireless media adapter 602 and is preferably used both for the wireless reception of audio content from TX wireless media adapter 302 and for audio sampling clock regeneration in accordance with the method described herein. The RX reference clock is selected to have an identical frequency (or as close as possible) to the TX reference clock of TX wireless media adapter 302, although in practice the TX and RX reference clocks may vary by a few parts per million (ppm).

The value M received as input by RX PLL reference generator 604 is a predefined value that is selected based on an audio format indicator which is wirelessly communicated from TX wireless media adapter 302 in a manner previously described. The integer values M Count and Adjustment Packets are also wirelessly communicated from TX wireless media adapter 302 and the generation and transmission of these values has already been described.

RX PLL reference generator 604 derives a BASE, 50% duty cycle input reference signal 608 to PLL 606 with a BASE input reference period equal to the RX reference clock times M Count. This BASE input reference period is always slightly less than the audio packet period, due to the inherent rounding down operation of the generation method.

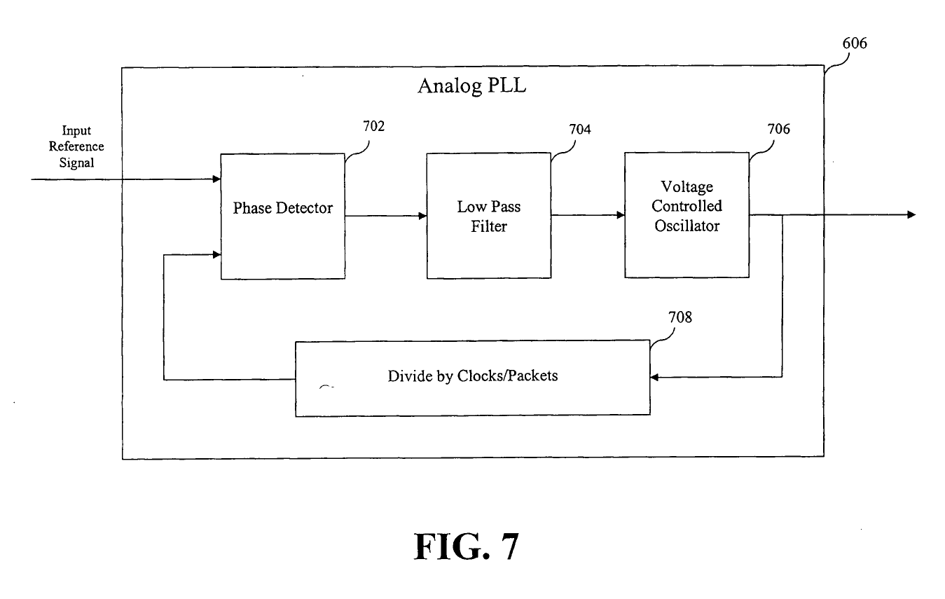

PLL 606 receives as input the number of bits per audio packet and the input reference signal 608 from the RX PLL reference generator. The number of bits per audio packet is a predefined value that is selected based on an audio format indicator which is wirelessly communicated to RX wireless media adapter 602 by TX wireless media adapter 302 in a manner previously described. FIG. 7 depicts an example analog implementation of PLL 606 that includes a phase detector 702, a low pass filter 704, a voltage controlled oscillator 706 and a feedback module 708.

The A/B parameters for PLL 606 are programmed to equal the number of bits per audio packet. The effect of setting the A/B parameters this way is to generate an output signal that is A/B times the input signal. Thus, in this case, the input reference signal 608 from RX PLL reference generator (representative of the audio packet rate) is multiplied by the number of bits per audio packet to generate an audio sampling clock rate, or regenerated audio sampling clock.

Furthermore, in one embodiment of the present invention, RX PLL reference generator 604 increases the period of the input reference signal 608 (representative of the audio packet period) by one RX reference clock for the first Adjustment Packets in each set of M audio packets. RX PLL reference generator 604 then reduces the period of the input reference signal 608 back to the BASE input reference period for the remaining number of audio packets in the set of M audio packets. The remaining number of audio packets in the set of M audio packets will equal M−Adjustment Packets.

Furthermore, in another embodiment, RX PLL reference generator 604 increases the period of the input reference signal 608 (representative of the audio packet period) by one RX reference clock for a number of audio packets E. Then RX PLL reference generator 604 reduces the period of the input reference signal 608 back to the BASE input reference period for a number of audio packets F, such that the total number of audio packets D over which the adjustment occurs is:

D=(Adjustment Packets/M*E)+((1−Adjustment Packets)/M*F).

The effects of the operation of RX PLL reference generator 604 and PLL 606 as previously described are as follows:

(1) The rate of change in input reference signal 608 is constrained to one RX reference clock period per audio packet, versus the N and CTS method described in the Background Section, in which the rate of change in the regenerated clock is not constrained (e.g., the output rate changes instantaneously whenever N and CTS are updated);

(2) The rate of change of the regenerated audio sampling clock (i.e., the output of PLL 606) is further reduced or smoothed due to the control loop bandwidth implementation of PLL 606; and

(3) The total amount of change in the period of input reference signal 608 in any set of M audio packets is always constrained to be a number of clocks that is less than the number M, versus the N and CTS method described in the Background Section, in which the amount of change per any N/CTS update period was only constrained by the maximum period difference between the TX reference clock and the RX reference clock.

### C. Long-Term Frequency Offset Drift Compensation in Accordance with an Embodiment of the Present Invention

The N and CTS clock regeneration method described above in the Background Section and the clock regeneration methods described above in Sections A and B each utilize TX and RX reference clocks to perform clock regeneration. Due to the independent nature of the sources (e.g., crystal oscillator, clock oscillator, etc.) for the TX and RX reference clocks, there will be a persistent, long term frequency offset drift between a TX wireless media adapter and a RX wireless media adapter. This long term, and possibly very slow, frequency offset drift will adversely affect the accuracy of any recovered clock generated from the RX reference clock.

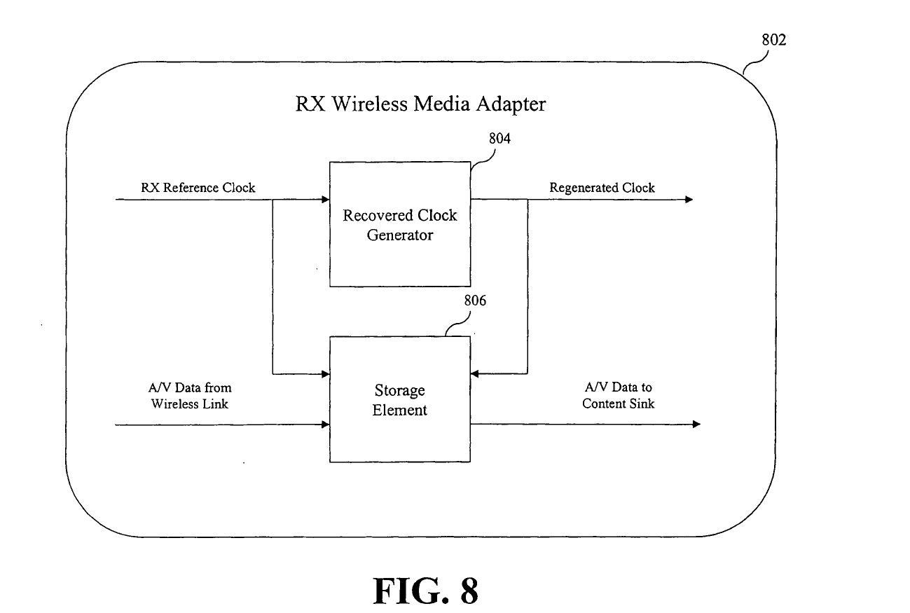

FIG. 8 illustrates an RX wireless media adapter 802 in accordance with an embodiment of the present invention that compensates for this frequency offset drift between the TX reference and RX reference clock sources. The compensation technique implemented by RX wireless media adapter 802 may be used with the N and CTS clock regeneration method described in the Background Section, with the clock regeneration methods described in Sections A and B, or in a standalone manner.

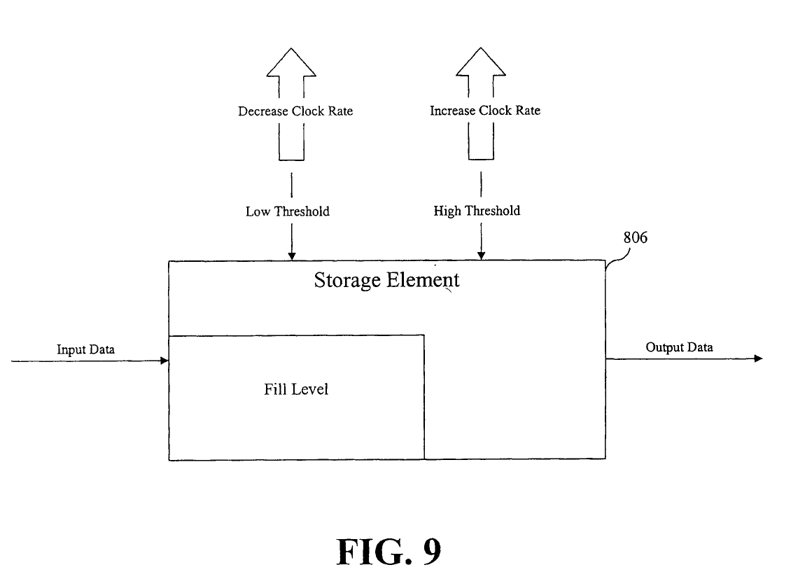

As shown in FIG. 8, RX wireless media adapter 802 includes a recovered clock generator 804 and a storage element 806 for temporarily buffering media content (e.g., audio/video (A/V) data) after it is wirelessly received from a TX wireless media adapter but before it is output to a content sink. A more detailed view of storage element 806 is depicted in FIG. 9.

Storage element 806 may include any type of memory, including but not limited to a random access memory (RAM) or a First-in-First-Out (FIFO).

Recovered clock generator 804 could be implemented using either the closed loop N and CTS method described in the Background Section, the clock regeneration methods described in Sections A and B, or as an open loop clock source set to a nominal clock frequency based upon a video or audio format indicator received from a TX wireless media adapter.

In all implementations, the BASE regenerated clock frequency is modified (or further modified in the closed loop cases) by closed loop control signals derived from the relative input and output rates of data into/out of storage element 806. The input rate into storage element 806 is based indirectly on both the source video pixel clock (or audio sample clock) on the TX wireless media adapter and the TX reference clock which is used to wirelessly transmit the media content. The output rate of storage element 806 is directly based on the regenerated clock from recovered clock generator 804. The additional closed loop control signals to recovered clock generator 804 are derived by setting (e.g., by programming) both a high threshold and a low threshold on the fill capacity of storage element 806.

Conceptually, this is similar to setting a high level to turn on a water pump in a water tank to prevent the tank from overflowing and setting a low level to turn off a water pump in a water tank to prevent the tank from going empty.

When the fill capacity of storage element 806 reaches the high threshold, this means that the source for the TX reference clock is faster than the source for the RX reference clock; therefore, the period of the regenerated clock from recovered clock generator 804 must be decreased (i.e., the storage element 806 output rate must be increased). Similarly, when the fill capacity of storage element 806 reaches the low threshold, this means that the source for the TX reference clock is slower than the source for the RX reference clock. Therefore, the period of the regenerated clock from recovered clock generator 804 must be increased (i.e., the storage element 806 output rate must be decreased). The high and low thresholds can be set based on the specified or expected maximum frequency offset drift of the TX reference and RX reference clock sources, the size of the storage element and/or the regenerated clock rate.

For the N and CTS clock regeneration method described in the Background Section, decreasing the storage element 806 output rate could be achieved by increasing the CTS value and increasing the storage element 806 output rate could by achieved by decreasing the CTS value based on these high/low thresholds.

For the clock regeneration methods described above in Sections A and B, the input reference signal to the PLL (from the RX PLL reference generator) could be increased or decreased by one RX reference clock for the entire adjustment period (video frame or M packets) based on these high/low thresholds. Note that this adjustment would be in addition to the one clock adjustment generated by the Adjustment Lines or Adjustment Packets parameters. However, the maximum rate of adjustment could still be limited to one RX reference clock per adjustment period but staggering the time at which the adjustments were applied by the RX PLL Reference generator.

For an open loop clock recovery method, the nominal regenerated clock frequency could be switch to a higher or lower frequency based upon these high/low thresholds.

### D. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for regenerating a pixel clock, comprising:
receiving an integer value that represents a number of remote reference clock cycles generated during a time reference period associated with one or more video frames integer divided by a number of horizontal video lines associated with the video frame(s);
generating an input reference signal having a period equal to a period of a local reference clock signal multiplied by the integer value; and
using a phase lock loop to multiply the input reference signal frequency by a number of pixels associated with a horizontal video line to provide a regenerated pixel clock.

2. The method of claim 1, wherein the time reference period associated with the video frame is one of: a video frame period, a video horizontal line period, or a period associated with multiple frames of video.

3. The method of claim 1, further comprising:
applying an adjustment to the input reference signal, wherein the adjustment is applied by extending the period of the input reference signal by no more than one clock cycle of the local reference clock per period of the input reference signal.

4. The method of claim 3, further comprising:
receiving an integer value representing an adjustment period;
wherein applying the adjustment to the input reference signal comprises applying the adjustment across a subset of horizontal lines in a video frame, wherein the number of horizontal lines in the subset is determined based on the adjustment period.

5. The method of claim 3, further comprising:
receiving an integer value representing an adjustment period;
wherein applying the adjustment to the input reference signal comprises applying the adjustment across a subset of video frames in a plurality of video frames, wherein the number of video frames in the subset is determined based on the adjustment period.

6. A system for regenerating a pixel clock, comprising:
a reference signal generator configured to generate an input reference signal having a period equal to a period of a local reference clock signal multiplied by an integer value, wherein the integer value represents a number of remote reference clock cycles generated during a time reference period associated with one or more video frames integer divided by a number of horizontal video lines associated with the video frame(s); and
a phase lock loop configured to multiply the input reference signal frequency by a number of pixels associated with a horizontal video line to provide a regenerated pixel clock.

7. The system of claim 6, wherein the time reference period associated with the video frame is one of: a video frame period, a video horizontal line period, or a period associated with multiple frames of video.

8. The system of claim 6, wherein the reference signal generator is further configured to apply an adjustment to the input reference signal, wherein the adjustment is applied by extending the period of the input reference signal by no more than one clock cycle of the local reference clock per period of the input reference signal.

9. The system of claim 8, wherein the reference signal generator is configured to apply the adjustment to the input reference signal by receiving an integer value representing an adjustment period and by applying the adjustment across a subset of horizontal lines in a video frame, wherein the number of horizontal lines in the subset is determined based on the adjustment period.

10. The system of claim 8, wherein the reference signal generator is configured to apply the adjustment to the input reference signal by receiving an integer value representing an adjustment period and by applying the adjustment across a subset of video frames in a plurality of video frames, wherein the number of video frames in the subset is determined based on the adjustment period.

11. A method for regenerating an audio sampling clock, comprising:
receiving an integer value that represents a number of remote reference clock cycles generated during a time reference period associated with one or more audio packets integer divided by M, wherein M is a positive integer;
generating an input reference signal having a period equal to a period of a local reference clock signal multiplied by the integer value; and
using a phase lock loop to multiply the input reference signal frequency by a number of bits associated with each audio packet to provide a regenerated audio sampling clock.

12. The method of claim 11, wherein the time reference period associated with one or more audio packets is a period of M audio packets.

13. The method of claim 11, further comprising:
applying an adjustment to the input reference signal, wherein the adjustment is applied by extending the period of the input reference signal by no more than one clock cycle of the local reference clock per period of the input reference signal.

14. The method of claim 13, further comprising:
receiving an integer value representing an adjustment period;
wherein applying the adjustment to the input reference signal comprises applying the adjustment across a subset of M audio packets, wherein the number of audio packets in the subset is determined based on the adjustment period.

15. The method of claim 13, further comprising:
receiving an integer value representing an adjustment period;
wherein applying the adjustment to the input reference signal comprises applying the adjustment across a subset of a plurality of blocks of M audio packets, wherein the number of blocks in the subset is determined based on the adjustment period.

16. A system for regenerating an audio sampling clock, comprising:
a reference signal generator configured to generate an input reference signal having a period equal to a period of a local reference clock signal multiplied by an integer value, wherein the integer value represents a number of remote reference clock cycles generated during a time reference period associated with one or more audio packets integer divided by M, wherein M is a positive integer; and
a phase lock loop configured to multiply the input reference signal frequency by a number of bits associated with each audio packet to provide a regenerated audio sampling clock.

17. The system of claim 16, wherein the time reference period associated with one or more audio packets is a period of M audio packets.

18. The system of claim 16, wherein the reference signal generator is further configured to apply an adjustment to the input reference signal, wherein the adjustment is applied by extending the period of the input reference signal by no more than one clock cycle of the local reference clock per period of the input reference signal.

19. The system of claim 18, wherein the reference signal generator is configured to apply the adjustment to the input reference signal by receiving an integer value representing an adjustment period and by applying the adjustment across a subset of M audio packets, wherein the number of audio packets in the subset is determined based on the adjustment period.

20. The system of claim 18, wherein the reference signal generator is configured to apply the adjustment to the input reference signal by receiving an integer value representing an adjustment period and by applying the adjustment across a subset of a plurality of blocks of M audio packets, wherein the number of blocks in the subset is determined based on the adjustment period.

21. A method for controlling a regenerated clock, comprising:
storing wirelessly-received media content in a storage element;
monitoring the storage element to determine if the amount of stored media content has reached a programmed threshold; and
responsive to determining that the amount of stored media content has reached the programmed threshold, changing the rate of a regenerated clock associated with the media content.

22. The method of claim 21 wherein the media content comprises video content and the regenerated clock comprises a regenerated pixel clock.

23. The method of claim 21, wherein the media content comprises audio content and the regenerated clock comprises an audio sampling clock.

24. The method of claim 21, wherein monitoring the storage element to determine if the amount of stored media content has reached a programmed threshold comprises monitoring the storage element to determine if the amount of stored media content has reached a high threshold; and
wherein changing the rate of the regenerated clock comprises increasing the rate of the regenerated clock.

25. The method of claim 21, wherein monitoring the storage element to determine if the amount of stored media content has reached a programmed threshold comprises monitoring the storage element to determine if the amount of stored media content has dropped to a low threshold; and
wherein changing the rate of the regenerated pixel clock comprises decreasing the rate of the regenerated pixel clock.

26. A system for controlling a regenerated clock, comprising:
a storage element configured to store wirelessly-received media content;
a recovered clock generator configured to monitor the storage element to determine if the amount of stored media content has reached a programmed threshold and to change the rate of a regenerated clock associated with the media content responsive to a determination that the amount of stored media content has reached the predefined threshold.

27. The system of claim 26, wherein the media content comprises video content and the regenerated clock comprises a regenerated pixel clock.

28. The system of claim 26, wherein the media content comprises audio content and the regenerated clock comprises an audio sampling clock.

29. The system of claim 26, wherein the recovered clock generator is configured to monitor the storage element to determine if the amount of stored media content has reached a high threshold and to increase the rate of the regenerated clock responsive to a determination that the amount of stored media content has reached the high threshold.

30. The system of claim 26, wherein the recovered clock generator is configured to monitor the storage element to determine if the amount of stored media content has dropped to a low threshold and to decrease the rate of the regenerated pixel clock responsive to a determination that the amount of stored media content has dropped to the low threshold.
